(19) United States
(12) Patent Application Publication
(10) Pub. No.: US 2023/0138951 A1
(43) Pub. Date: May 4, 2023

(54) PNEUMATIC TIRE

(71) Applicant: Sumitomo Rubber Industries, Ltd., Kobe-shi (JP)

(72) Inventor: Hiroki MIZOKAWA, Kobe-shi (JP)

(73) Assignee: Sumitomo Rubber Industries, Ltd., Kobe-shi (JP)

(21) Appl. No.: 17/959,026

(22) Filed: Oct. 3, 2022

(30) Foreign Application Priority Data
Nov. 4, 2021 (JP) 2021-180451

(51) Int. Cl. B60C 15/06

(52) U.S. Cl. CPC B60C 15/0628; B60C 2015/0614; B60C 2015/0678

(57) ABSTRACT

A pneumatic tire includes a pair of bead portions, a pair of bead cores, and a carcass extending between the bead cores. The carcass includes a carcass ply including a main portion extending between the bead cores and a pair of turn-up portions each turned up around a respective one of the bead cores from axially inside to the outside of the tire and extending radially outwardly. In at least one of the bead portions, a reinforcing rubber layer is disposed outwardly and adjacently in the tire axial direction of the turn-up portion. The reinforcing rubber layer includes a first rubber layer and a second rubber layer arranged outwardly in the tire axial direction of the first rubber layer. A loss tangent tan δ1 of the first rubber layer is smaller than a loss tangent tan δ2 of the second rubber layer.

### RELATED APPLICATIONS

This application claims the benefit of foreign priority to Japanese Patent Application No. JP2021-180451, filed Nov. 4, 2021, which is incorporated by reference in its entirety.

### FIELD OF THE DISCLOSURE

The present disclosure relates to a pneumatic tire.

### BACKGROUND OF THE DISCLOSURE

The following Patent Document 1 discloses a pneumatic tire expected to have improved durability. A bead apex rubber is arranged in each bead portion in the pneumatic tire. The bead apex rubber includes a main body apex extending from the outer surface of the bead core in the tire radial direction and an outer apex arranged outside the main body apex in the tire axial direction.

### PATENT DOCUMENT

[Patent Document 1] Japanese Unexamined Patent Application Publication 2020-93755

### SUMMARY OF THE DISCLOSURE

As described above, the pneumatic tire having a so-called outer apex structure has room for improvement in the durability of the bead portion under high load conditions.

The present disclosure has been made in view of the above circumstances and has a main object to improve bead durability in a pneumatic tire having an outer apex structure.

In one aspect of the present disclosure, a pneumatic tire includes a pair of bead portions, a pair of bead cores each disposed in a respective one of the bead portions, and a carcass extending between the pair of bead cores. The carcass includes a carcass ply including a main portion extending between the pair of bead cores and a pair of turn-up portions each turned up around a respective one of the bead cores from inside to outside of the tire in a tire axial direction and extending outwardly in a tire radial direction. In at least one of the pair of bead portions, a reinforcing rubber layer is disposed outwardly and adjacently in the tire axial direction of the turn-up portion. The reinforcing rubber layer includes a first rubber layer and a second rubber layer arranged outwardly in the tire axial direction of the first rubber layer. A loss tangent tan δ1 of the first rubber layer is smaller than a loss tangent tan δ2 of the second rubber layer.

### SUMMARY OF THE DISCLOSURE

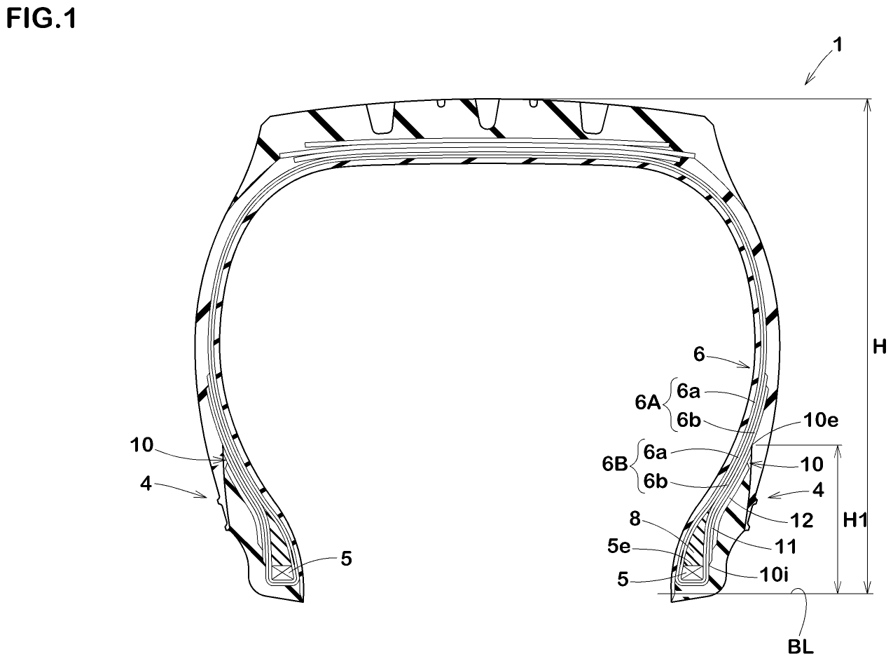

FIG. 1 is a tire meridian cross-sectional view of a pneumatic tire according to an embodiment of the present disclosure; and

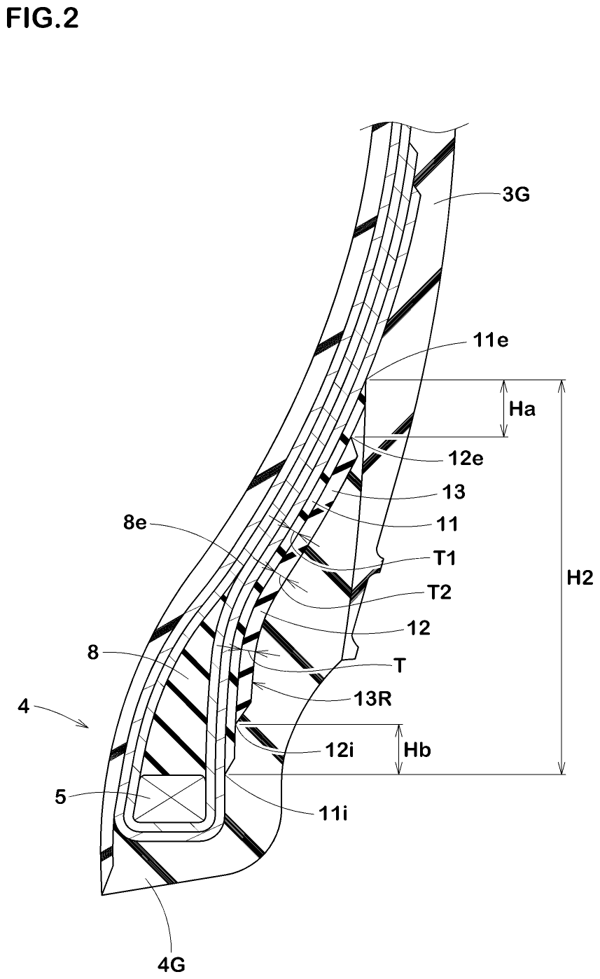

FIG. 2 is an enlarged view of a bead portion of FIG. 1.

### DETAILED DESCRIPTION OF THE DISCLOSURE

Hereinafter, an embodiment of the present disclosure will be described with reference to the drawings.

FIG. 1 is a tire meridian cross-sectional view including the tire axis of a pneumatic tire (hereafter, it may be simply referred to as “tire”) 1 under a normal state according to an embodiment of the present disclosure. The present disclosure, for example, may be used in tires 1 for commercial vehicles and light trucks. However, the present disclosure may also be used for tires for passenger cars or heavy-duty vehicles.

As used herein, the “normal state” is such that the tire 1 is mounted onto a standard wheel rim (not illustrated) with a standard pressure but loaded with no tire load. Unless otherwise noted, dimensions of portions of the tire 1 are values measured under the normal state.

As used herein, the “standard wheel rim” is a wheel rim officially approved for each tire by standards organizations on which the tire is based, wherein the standard wheel rim is the “standard rim” specified in JATMA, the “Design Rim” in TRA, and the “Measuring Rim” in ETRTO, for example.

As used herein, the “standard pressure” is a standard pressure officially approved for each tire by standards organizations on which the tire is based, wherein the standard pressure is the “maximum air pressure” in JATMA, the maximum pressure given in the “Tire Load Limits at Various Cold Inflation Pressures” table in TRA, and the “Inflation Pressure” in ETRTO, for example.

As illustrated in FIG. 1, the tire 1 according to the present embodiment includes a pair of bead portions 4, a pair of bead cores 5 each disposed in a respective one of the bead portions 4, and a carcass extending between the bead cores 5.

The carcass 6 includes a carcass ply 6A which includes a main portion 6a extending between the bead cores 5 and a pair of turn-up portions 6b each turned up around a respective one of the bead cores 5 from inside to outside of the tire in the tire axial direction and extending outwardly in the tire radial direction. The carcass 6, in the present embodiment, is composed of two carcass plies 6A and 6B which are superimposed with each other in the tire radial direction. Each carcass ply 6A and 6B includes the main portion 6a and the pair of turn-up portions 6b. The carcass 6, for example, may be composed of a single carcass ply 6A (not illustrated).

In at least one of the pair of bead portions 4, a reinforcing rubber layer 10 is disposed outwardly and adjacently in the tire axial direction of the turn-up portion 6b. The reinforcing rubber layer 10 can enhance the rigidity of the bead portion 4, improving durability thereof.

In the present embodiment, the reinforcing rubber layer 10 is arranged in each bead portion 4.

Each reinforcing rubber layer 10, for example, is adjacent to an outer surface in the tire axial direction of each turn-up portion 6b of the radially inner carcass ply 6A.

Each reinforcing rubber layer 10 includes a first rubber layer 11 and a second rubber layer 12 arranged outwardly in the tire axial direction of the first rubber layer 11. Further, a loss tangent tan δ1 of the first rubber layer 11 is smaller than a loss tangent tan δ2 of the second rubber layer 12. Thus, the first rubber layer 11 has a small hysteresis loss, which can suppress its heat generation. This can prevent the carcass plies 6A and 6B from being damaged by heat. In addition, the second rubber layer 12 has the basic effect of suppressing the distortion of the bead portions 4. Thus, the durability performance of the tire can be greatly improved.

In order to effectively exert the above-mentioned effects, the loss tangent tan δ1, for example, is preferably equal to or more than 0.07, more preferably equal to or more than 0.12, but preferably equal to or less than 0.17, more preferably equal to or less than 0.14. For example, the loss tangent tan δ1 is preferably equal to or more than 60% of the loss tangent tan δ2, more preferably equal to or more than 70%, but preferably equal to or less than 95% of the loss tangent tan δ2, more preferably equal to or less than 90%.

In this specification, loss tangent tan δ and complex elastic modulus E*described later are values measured under the following conditions using a viscoelastic spectrometer in accordance with the provisions of JIS K6394 “Rubber, vulcanized or thermoplastic-determination of dynamic properties-General guidance”.
Initial distortion: 10%
Amplitude: plus/minus 2%
Frequency: 10 Hz
Deformation mode: Tension
Temperature: 70 degrees C.
Viscoelastic spectrometer: GABO “Iplexer” (registered trademark)

Preferably, a complex elastic modulus E*2 of the second rubber layer 12 is larger than a complex elastic modulus E*1 of the first rubber layer 11. As a result, the rigidity of the second rubber layer 12, which is located relatively outside in the tire axial direction, can be increased, the bead distortion can be suppressed under high load conditions, and the bead durability can be improved. When the complex elastic modulus E*2 of the second rubber layer 12 is excessively larger than the complex elastic modulus E*1 of the first rubber layer 11, the heat generated by the second rubber layer 12 may be conducted to the carcass plies 6A and 6B via the first rubber layer 11. Thus, the complex elastic modulus E*2 is preferably equal to or more than 120% of the complex elastic modulus E*l, more preferably equal to or more than 130%, but preferably equal to or less than 200% of the complex elastic modulus E*1, more preferably equal to or less than 190%. Although not particularly limited, the complex elastic modulus E*1 is preferably equal to or more than 20 MPa, more preferably equal to or more than 30 MPa, but preferably equal to or less than 110 MPa, more preferably equal to or less than 80 MPa.

Preferably, the innermost end 10i in the tire radial direction of each reinforcing rubber layer 10 is located within 10 mm in the tire radial direction from the outermost end 5e of the bead core 5 in the tire radial direction. When the innermost end 10i of the reinforcing rubber layer 10 is located more than 10 mm outward in the tire radial direction from the outermost end 5e of the bead core 5, it may be difficult to suppress the distortion of the bead part 4. When the innermost end 10i of the reinforcing rubber layer 10 is located more than 10 mm inward in the tire radial direction from the outermost end 5e of the bead core 5, it may not contribute to the improvement of the rigidity of the bead portion 4, and for example, the mass of the tire 1 may increase and the rim assembly property may decrease.

Preferably, a height H1 in the tire radial direction from the bead baseline BL to an outermost end 10e of the reinforcing rubber layer 10 is equal to or more than 25% of the tire cross-sectional height H. As a result, the rigidity of a portion where the bead portion 4 is greatly distorted can be surely increased. When the height H1 is excessively large, it may lead to an increase in tire mass, for example. From this point of view, the height H1 is more preferably equal to or more than 30%, but preferably equal to or less than 50%, more preferably equal to or less than 45% of the tire cross-sectional height H.

As used herein, the “bead baseline BL” is the tire axial line passing through the rim diameter (see JATMA) position determined by the standard based on the tire 1. Also, the “tire cross-sectional height H” is the distance in the tire radial direction from the bead baseline BL to the outermost position of the tire in the tire radial direction.

FIG. 2 is an enlarged view of one of the bead portions 4 of FIG. 1. As illustrated in FIG. 2, the first rubber layer 11 and the second rubber layer 12, for example, are formed of sheet-shaped rubber members 13. In other words, the reinforcing rubber layer 10 according to the present embodiment is formed as a laminated body 13R in which the sheet-shaped rubber members 13 are laminated in the tire axial direction. Such a reinforcing rubber layer 10 can increase the rigidity of the bead portion 4 and suppress a large increase in mass.

Each of the sheet-shaped rubber members 13, for example, has a constant thickness T in more than 90% of its length. The reinforcing rubber layer 10 formed of such rubber members 13 can be able to have high rigidity so that the durability of the bead portion 4 can be improved. As used herein, the above-mentioned “constant thickness” includes a portion where the thickness changes by 0.2 mm/mm or less in the direction orthogonal to the thickness of the sheet-shaped rubber member 13.

Preferably, a thickness T2 of the second rubber layer 12 is greater than a thickness T1 of the first rubber layer 11. As a result, the reinforcing rubber layer 10 has greater rigidity, and thus the durability performance can further be improved. Although not particularly limited, the thickness T2 of the second rubber layer 12 is preferably equal to or more than 130% of the thickness T1 of the first rubber layer 11, more preferably equal to or more than 140%, but preferably equal to or less than 170% of the thickness T1 of the first rubber layer 11, more preferably equal to or less than 160%. The thickness T2 of the second rubber layer 12 is preferably equal to or more than 1.0 mm, more preferably equal to or more than 1.2 mm, but preferably equal to or less than 2.5 mm, more preferably equal to or less than 2.0 mm.

Preferably, the outermost end 11e in the tire radial direction of the first rubber layer 11 is located outwardly in the tire radial direction of the outermost end 12e in the tire radial direction of the second rubber layer 12. Such a first rubber layer 11 can effectively suppress the heat generated by the second rubber layer 12 from being conducted to the carcass 6. A separation distance Ha in the tire radial direction between the outermost end 11e of the first rubber layer 11 and the outermost end 12e of the second rubber layer 12 is preferably equal to or more than 2% of a tire radial length H2 of the first rubber layer 11, more preferably equal to or more than 5%, but preferably equal to or less than 20% of the tire radial length H2 of the first rubber layer 11, more preferably equal to or less than 10%.

In the present embodiment, in order to exert the same effect, the innermost end 11i in the tire radial direction of the first rubber layer 11 is located inwardly in the tire radial direction of the innermost end 12i of the second rubber layer 12. A separation distance Hb in the tire radial direction between the innermost end 11i of the first rubber layer 11 and the innermost end 12i of the second rubber layer 12 is preferably equal to or more than 2% of the tire radial length H2 of the first rubber layer 11, more preferably equal to or more than 5%, but preferably equal to or less than 20% of the tire radial length H2 of the first rubber layer 11, more preferably equal to or less than 10%.

Each bead portion 4 according to the present embodiment is provided with a bead apex rubber 8 extending outwardly in the tire radial direction from the bead core 5 and a clinch rubber 4G arranged outwardly in the axial direction of the reinforcing rubber layer 10. In addition, a sidewall rubber 3G is arranged outwardly in the tire axial direction of the clinch rubber 4G, for example. The sidewall rubber 3G and the clinch rubber 4G form an outer surface of the tire.

In each bead portion 4, the bead apex rubber 8 is formed in a triangular shape, for example, in a tire meridian cross-sectional view. Although not particularly limited, the first rubber layer 11 and the second rubber layer 12 are arranged at the height position in the tire radial direction of the outermost end 8e in the tire radial direction of the bead apex rubber 8.

Preferably, a complex elastic modulus E*3 of each bead apex rubber 8, for example, is larger than the complex elastic modulus E*1 of the first rubber layer 11. Preferably, the complex elastic modulus E*3 of each bead apex rubber 8, for example, is smaller than the complex elastic modulus E*2 of the second rubber layer 12.

The complex elastic modulus E*of sidewall rubber 3G and clinch rubber 4G are both smaller than the complex elastic modulus E*1 of the first rubber layer 11. This can be helpful to provide basic ride comfort performance.

Although an embodiment of the present disclosure has been described in detail above, the present disclosure is not limited to the specific embodiment described above but may be modified and carried out in various aspects.

### Example

Some kinds of pneumatic tires with the basic structure shown in FIG. 1 were prepared based on the specifications in Table 1. Then, the durability performance of each test tire was tested. The common specifications of each test tire and the test method are as follows.

### Durability Test:

Each test tire was run on a drum tester under the following conditions, and the mileage until damage occurred in either one of the bead portions was measured. The test results were shown in Table 1 using an index with Comparative Example 1 as 100. The larger the value, the better.
Tire size: 225/85R16
Rim: 6.0 J
Internal pressure: 220 kPa
Load: 19.84 kN
tan δ1:0.13
E*1:30 MPa

The test results are shown in Table 1. In Table 1, “A” indicates a separation distance in the tire radial direction between the innermost end of the reinforcing rubber layer and the outermost end of the bead core in each bead portion, and the outermost end of the bead core is located outwardly in the tire radial direction than the innermost end of the reinforcing rubber layer.

TABLE 1

| | Comparative | Comparative | Comparative | | | | | | |
|---|---|---|---|---|---|---|---|---|---|
| | ex. 1 | ex. 2 | ex. 3 | Ex. 1 | Ex. 2 | Ex. 3 | Ex. 4 | Ex. 5 | Ex. 6 |
| Number of rubber sheets | 1 | 2 | 2 | 2 | 2 | 2 | 2 | 2 | 2 |
| of reinforcing rubber layer | | | | | | | | | |
| Ratio tanδ1/tanδ2 (%) | — | 100 | 125 | 75 | 90 | 75 | 75 | 75 | 75 |
| Ratio E*2/E*1 (%) | — | 100 | 80 | 180 | 180 | 130 | 180 | 180 | 180 |
| Separation distance A (mm) | 8 | 8 | 8 | 8 | 8 | 8 | 12 | 8 | 8 |
| Ratio H1/H (%) | 30 | 30 | 30 | 30 | 30 | 30 | 30 | 20 | 20 |
| First rubber layer | 1.5 | 1.0 | 1.0 | 1.0 | 1.0 | 1.0 | 1.0 | 1.0 | 1.5 |
| thickness T1 (mm) | | | | | | | | | |
| Second rubber layer | — | 1.5 | 1.5 | 1.5 | 1.5 | 1.5 | 1.5 | 1.5 | 1.0 |
| thickness T2 (mm) | | | | | | | | | |
| T1 + T2 (mm) | 1.5 | 2.5 | 2.5 | 2.5 | 2.5 | 2.5 | 2.5 | 2.5 | 2.5 |
| Durability test [index] | 100 | 110 | 105 | 150 | 120 | 125 | 130 | 130 | 140 |

As a result of the test, it is confirmed that the tires of the examples have improved durability performance as compared to the tires of the comparative examples.

### [Additional Notes]

The present disclosure includes the following aspects.

### [Note 1]

A pneumatic tire comprising:

a pair of bead portions:

a pair of bead cores each disposed in a respective one of the bead portions; and

a carcass extending between the pair of bead cores, wherein

the carcass comprises a carcass ply comprising a main portion extending between the pair of bead cores and a pair of turn-up portions each turned up around a respective one of the bead cores from inside to outside of the tire in a tire axial direction and extending outwardly in a tire radial direction,

in at least one of the pair of bead portions, a reinforcing rubber layer is disposed outwardly and adjacently in the tire axial direction of the turn-up portion,

the reinforcing rubber layer comprises a first rubber layer and a second rubber layer arranged outwardly in the tire axial direction of the first rubber layer, and

a loss tangent tan δ1 of the first rubber layer is smaller than a loss tangent tan δ2 of the second rubber layer.

### [Note 2]

The pneumatic tire according to note 1, wherein

a complex elastic modulus E*2 of the second rubber layer is larger than a complex elastic modulus E*1 of the first rubber layer.

### [Note 3]

The pneumatic tire according to note 2, wherein

the complex elastic modulus E*2 of the second rubber layer is equal to or more than 150% of the complex elastic modulus E*1 of the first rubber layer.

### [Note 4]

The pneumatic tire according to any one of notes 1 to 3, wherein an innermost end in the tire radial direction of the reinforcing rubber layer is located within 10 mm in the tire radial direction from an outermost end of the bead core in the tire radial direction.

### [Note 5]

The pneumatic tire according to any one of notes 1 to 4, wherein

a height in the tire radial direction from a bead baseline to an outermost end of the reinforcing rubber layer is equal to or more than 25% of a tire cross-sectional height.

### [Note 6]

The pneumatic tire according to any one of notes 1 to 5, wherein a thickness of the second rubber layer is greater than a thickness of the first rubber layer.

### [Note 7]

The pneumatic tire according to any one of notes 1 to 6, wherein

an outermost end in the tire radial direction of the first rubber layer is located outwardly in the tire radial direction of an outermost end in the tire radial direction of the second rubber layer.

### [Note 8]

The pneumatic tire according to any one of notes 1 to 7, wherein

an innermost end in the tire radial direction of the first rubber layer is located inwardly in the tire radial direction of an innermost end in the tire radial direction of the second rubber layer.

1. A pneumatic tire comprising:
a pair of bead portions;
a pair of bead cores each disposed in a respective one of the bead portions; and
a carcass extending between the pair of bead cores, wherein
the carcass comprises a carcass ply comprising a main portion extending between the pair of bead cores and a pair of turn-up portions each turned up around a respective one of the bead cores from inside to outside of the tire in a tire axial direction and extending outwardly in a tire radial direction,
in at least one of the pair of bead portions, a reinforcing rubber layer is disposed outwardly and adjacently in the tire axial direction of the turn-up portion,
the reinforcing rubber layer comprises a first rubber layer and a second rubber layer arranged outwardly in the tire axial direction of the first rubber layer, and
a loss tangent tan δ1 of the first rubber layer is smaller than a loss tangent tan δ2 of the second rubber layer.

2. The pneumatic tire according to claim 1, wherein
a complex elastic modulus E*2 of the second rubber layer is larger than a complex elastic modulus E*1 of the first rubber layer.

3. The pneumatic tire according to claim 2, wherein
the complex elastic modulus E*2 of the second rubber layer is equal to or more than 150% of the complex elastic modulus E*1 of the first rubber layer.

4. The pneumatic tire according to claim 1, wherein
an innermost end in the tire radial direction of the reinforcing rubber layer is located within 10 mm in the tire radial direction from an outermost end of the bead core in the tire radial direction.

5. The pneumatic tire according to claim 1, wherein
a height in the tire radial direction from a bead baseline to an outermost end of the reinforcing rubber layer is equal to or more than 25% of a tire cross-sectional height.

6. The pneumatic tire according to claim 1, wherein
a thickness of the second rubber layer is greater than a thickness of the first rubber layer.

7. The pneumatic tire according to claim 1, wherein
an outermost end in the tire radial direction of the first rubber layer is located outwardly in the tire radial direction of an outermost end in the tire radial direction of the second rubber layer.

8. The pneumatic tire according to claim 1, wherein
an innermost end in the tire radial direction of the first rubber layer is located inwardly in the tire radial direction of an innermost end in the tire radial direction of the second rubber layer.

9. The pneumatic tire according to claim 1, wherein
the loss tangent tan δ1 of the first rubber layer is in a range from 0.07 to 0.17.

10. The pneumatic tire according to claim 9, wherein
the loss tangent tan δ1 of the first rubber layer is equal to or more than 0.12.

11. The pneumatic tire according to claim 9, wherein
the loss tangent tan δ1 is in a range from 60% to 95% of the loss tangent tan δ2.

12. The pneumatic tire according to claim 9, wherein
the loss tangent tan δ1 is in a range from 75% to 90% of the loss tangent tan δ2.

13. The pneumatic tire according to claim 3, wherein
the complex elastic modulus E*2 of the second rubber layer is equal to or less than 200% of the complex elastic modulus E*1 of the first rubber layer.

14. The pneumatic tire according to claim 1, wherein
the first rubber layer has a constant thickness in more than 90% of its length.

15. The pneumatic tire according to claim 14, wherein
the second rubber layer has a constant thickness in more than 90% of its length.

18. The pneumatic tire according to claim 15, wherein
a thickness T2 of the second rubber layer is in a range from 130% to 170% of a thickness T1 of the first rubber layer.

19. The pneumatic tire according to claim 18, wherein
the thickness T2 of the second rubber layer is in a range from 1.0 to 2.5 mm.

20. The pneumatic tire according to claim 1, wherein
in the at least one of the bead portions, a clinch rubber is arranged outwardly in the axial direction of the reinforcing rubber layer, and
a clinch rubber has a complex elastic modulus E*smaller than a complex elastic modulus E*1 of the first rubber layer.
